(19) United States
(12) Patent Application Publication
(10) Pub. No.: US 2026/0005245 A1
(43) Pub. Date: Jan. 1, 2026

(54) PITCH-BASED GRAPHITE COMPOSITE MATERIAL, PREPARATION METHOD THEREFOR AND APPLICATION THEREOF

(71) Applicants: Taiyuan University of Technology, Taiyuan (CN); Shanxi Longxing Energy Technology Co., LTD, Taiyuan (CN)

(72) Inventors: Song YANG, Taiyuan (CN); Dong WEI, Taiyuan (CN); Shoujun LIU, Taiyuan (CN); Zhicong ZHANG, Taiyuan (CN); Liangyu CHEN, Taiyuan (CN); Jin LI, Taiyuan (CN); Pengtao WANG, Taiyuan (CN); Xiao GAO, Taiyuan (CN)

(73) Assignees: Taiyuan University of Technology, Taiyuan (CN); Shanxi Longxing Energy Technology Co., LTD, Taiyuan (CN)

(21) Appl. No.: 18/932,646

(22) Filed: Oct. 31, 2024

(30) Foreign Application Priority Data
Jun. 27, 2024 (CN) 202410848084.8

(51) Int. Cl. H01M 4/587; C01B 32/21; C10C 3/02; H01M 4/36

(52) U.S. Cl. CPC H01M 4/587; C01B 32/21; C10C 3/023; H01M 4/366; C01P 2004/03; C01P 2004/04; C01P 2004/32; C01P 2004/80; C01P 2006/40

(57) ABSTRACT

A pitch-based graphite composite material, a preparation method therefor and an application thereof are provided. The graphite is coated with pitch gel spheres, and a core-shell composite structure of pitch carbon microsphere coated graphite is obtained through pyrolysis and carbonization, so that the contact between a graphite surface and an electrolyte can be effectively reduced, a stable SEI film can be generated, and the SEI film has good rate and cycle performance. In addition, a porous structure formed by gas generated by pyrolysis and carbonization is beneficial to the transportation of lithium ions, the conductivity and reversible capacity of the material can be significantly improved, the material is more stable in the charging and discharging processes of the lithium-ion battery, the risks of stripping and cracking are effectively reduced, and the cycle stability and the rate capability of the battery are improved.

### CROSS REFERENCE TO THE RELATED APPLICATIONS

This application is based upon and claims priority to Chinese Patent Application No. 202410848084.8, filed on Jun. 27, 2024, the entire contents of which are incorporated herein by reference.

### TECHNICAL FIELD

The present invention relates to the technical field of lithium-ion batteries, and in particular, to a pitch-based graphite composite material, a preparation method therefor and an application thereof.

### BACKGROUND

Lithium-ion batteries have been widely used since introduction due to the advantages of being green and environmentally friendly, and having high energy density, light weight and no memory effect. Graphite is the negative electrode material mainly used in commercial lithium-ion batteries, and has a theoretical specific capacity of only 372 mAh·g⁻¹. The layered structure of the graphite easily leads to co-embedding of electrolyte ions, continuous formation of SEI film, consumption of lithium ions, and destruction of graphite structure, thus affecting the cycle stability and coulombic efficiency of the battery. Meanwhile, the anisotropic structural characteristics of graphite limit the free diffusion of lithium ions in the graphite structure, thus affecting the rate performance of graphite negative electrode materials. These problems require modification of graphite to meet the requirements of high performance lithium-ion batteries.

At present, the most important modification mode of graphite is carbon coating modification, which is a modification mode that uses “graphite” as the core and coats “amorphous carbon” as a protective shell to form a core-shell structure. The coating method is mostly solid phase coating in industrial production. According to Chinese Patent CN1624956A, spherical graphite with a small particle size and high-softening-point pitch are mixed uniformly, then the mixture is put into a high-temperature furnace into which nitrogen is introduced for heat treatment, the heat-treated powder is sieved to obtain a pitch-coated graphite product. This method is simple to operate and low in cost, but has the problem that the precursor has a difficulty in penetrating into the gaps and depositing, resulting in incomplete coating. According to Natarajan (Natarajan C, Fujimoto H, Tokumitsu K, et al. Reduction of the irreversible capacity of a graphite anode by the CVD process [J]. Carbon, 2001, 39(9):1409-1413. DOI: 10.1016/S0008-6223(00)00267-0.) (Carbon, 2001, 39(9):), the pyrolytic carbon-coated graphite is prepared by CVD method, which solves the problem of incomplete coating in solid phase coating; however, the cost is too high in actual production.

The liquid phase chemical method uses chemical reaction in a wet environment to form a modified additive to coat the surface of the particles. The commonly used liquid phase coating methods comprise hydrothermal method, precipitation method, sol-gel method, chemical plating method, and the like. The liquid phase coating can theoretically penetrate into the interior of the particles like CVD method to form a core-shell structure more easily, and the cost is lower. Therefore, the application of liquid phase coating method is a more suitable choice. However, the liquid phase coating method still has the phenomenon of agglomeration of the coated sample after heat treatment. For example, Chinese patent CN101582503A provides a method for coating spheroidized natural graphite by mixing pitch and washing oil, which has relatively high requirements on the particle size of pitch and graphite. In addition, the negative electrode material modified by coating amorphous carbon, due to the low electrochemical performance of amorphous carbon, needs to be further added with a conductive agent to further improve the electrochemical performance. For example, Chinese Patent CN101604748A prepares a mixed solution containing a graphitization catalyst, water and ethanol, then graphite, pitch powder and a conductive agent are added thereto, the mixture is mixed for several hours, the obtained mixture is dried in the air atmosphere, then the pitch is pyrolyzed in Ar or N₂ atmosphere, finally the graphitization catalyst is removed by dissolving with a nitric acid solution, and a negative electrode material of pyrolyzed pitch coated graphite for high-rate lithium-ion capacitor batteries is obtained. However, this method has the problems of complex preparation process and long cycle.

### SUMMARY

An objective of the present invention is to provide a pitch-based graphite composite material, a preparation method therefor and an application thereof, which has simple process flow and mild operation conditions, and can improve the cycle stability and the rate capability of lithium-ion batteries.

In order to achieve the above objective, the present invention provides the following technical solutions.

The present invention provides a preparation method for a pitch-based graphite composite material, which comprises the following steps:
mixing graphite, a surfactant and alkali liquor to obtain dispersion;
mixing the dispersion, water-soluble mesophase pitch and an alcohol solvent, performing precipitation reaction, and then aging to obtain a precursor; and
sequentially performing first pyrolysis and second pyrolysis on the precursor in a protective gas to obtain the pitch-based graphite composite material.

Preferably, the surfactant comprises cetyltrimethylammonium bromide, polyvinylpyrrolidone, carboxymethyl cellulose, or sodium alginate; a mass ratio of the graphite to the surfactant is 10:(0-2), and an amount of the cetyltrimethylammonium bromide is not 0.

Preferably, a preparation method for the water-soluble mesophase pitch comprises the following steps:
mixing concentrated sulfuric acid, concentrated nitric acid and high-temperature coal tar pitch for a first reaction to obtain a first product, wherein the high-temperature coal tar pitch is a coal tar pitch with a softening point greater than 95° C.;
standing the first product in water, washing until the pH value is 2, mixing an obtained solid product with an alkali solution for a second reaction to obtain a second product; and
mixing a second product with an acid solution for a third reaction to obtain the water-soluble mesophase pitch.

Preferably, a volume ratio of the concentrated sulfuric acid to the concentrated nitric acid is 3:(0-7), an amount of the concentrated nitric acid is not 0, a mass fraction of H₂SO₄ in the concentrated sulfuric acid is 98.3%, and a mass fraction of HNO₃ in the concentrated nitric acid is 65%.

Preferably, a mass ratio of the graphite to the water-soluble mesophase pitch is 10:(0.5-2), and the alcohol solvent comprises ethanol.

Preferably, the precipitation reaction is performed at a temperature of 30-80° C. for 0.5-3 h, and the aging is performed at a temperature of 85-90° C. for 10-24 h.

Preferably, the protective gas comprises nitrogen, argon or helium.

Preferably, the first pyrolysis is performed at a temperature of 300-450° C., and the heat preservation time is 5-30 min; a heating rate of heating to the temperature of the first pyrolysis is 3-10° C./min; the second pyrolysis is performed at a temperature of 700-800° C., and the heat preservation time is 2-5 h; and a heating rate of heating to the temperature of the second pyrolysis is 3-5° C./min.

The present invention provides a pitch-based graphite composite material prepared by the preparation method according to the above technical solution, which comprises: graphite and pitch carbon microspheres coated on a surface of the graphite, wherein the pitch carbon microspheres are connected to the graphite through a surfactant.

The present invention provides an application of the pitch-based graphite composite material according to the above technical solution in a negative electrode material for a lithium-ion battery.

The present invention provides a preparation method for a pitch-based graphite composite material, wherein the graphite is coated with pitch gel spheres, and a core-shell composite structure of pitch carbon microsphere coated graphite is obtained through pyrolysis and carbonization. In the process of the precipitation reaction, the positively charged groups in a surfactant are combined with carboxyl/graphite surface hydroxyl groups in the water-soluble mesophase pitch, and the negatively charged atom are combined with positively charged nitro groups in the aqueous mesophase pitch. Therefore, according to the present invention, the hydrophilicity and lipophilicity of the surfactant are used to be respectively combined with the mesophase pitch and the graphite, so that good coating effect (uniform coating) and good compatibility with the electrolyte are ensured, the contact between the graphite surface and the electrolyte can be effectively reduced, a stable SEI film (a solid electrolyte interface film on the graphite surface) is generated, and good rate and cycle performance are ensured. In addition, a porous structure formed by gas generated by pyrolysis and carbonization is beneficial to the transportation of lithium ions, the conductivity and reversible capacity of the material can be significantly improved, the material is more stable in the charging and discharging processes of the lithium-ion battery, the risks of stripping and cracking are effectively reduced, and the cycle stability and the rate capability of the battery are improved.

The preparation method of the present invention has the advantages of simple process flow, simple and easily available raw materials, mild operation conditions and convenient realization of industrialization.

### BRIEF DESCRIPTION OF THE DRAWINGS

FIG. 1 is an SEM image of high-temperature coal tar pitch used in Example 1;

FIG. 2 is an SEM image of water-soluble mesophase pitch prepared in Example 1;

FIG. 3 is an SEM image of a raw material spherical graphite according to Example 1;

FIG. 4 is an SEM image of a pitch-based graphite composite material according to Example 1;

FIG. 5 is a TEM image of a pitch-based graphite composite material according to Example 1; and

FIG. 6 is a curve showing the pore size distribution of a raw material graphite and a pitch-based graphite composite material according to Example 1.

### DETAILED DESCRIPTION OF THE EMBODIMENTS

The present invention provides a preparation method for a pitch-based graphite composite material, which comprises the following steps:
mixing graphite, a surfactant and alkali liquor to obtain dispersion;
mixing the dispersion, water-soluble mesophase pitch and an alcohol solvent, performing precipitation reaction, and then aging to obtain a precursor; and
sequentially performing first pyrolysis and second pyrolysis on the precursor in a protective gas to obtain the pitch-based graphite composite material.

In the present invention, unless otherwise specified, the required raw materials for preparation are all commercially available products well known to those skilled in the art.

In the present invention, graphite, a surfactant and alkali liquor are mixed to obtain a dispersion.

In the present invention, the graphite is preferably spherical graphite. The specification and source of the spherical graphite are not particularly limited in the present invention, and commercially available products well known in the art may be used.

In the present invention, the surfactant preferably comprises cetyltrimethylammonium bromide, polyvinylpyrrolidone, carboxymethyl cellulose, or sodium alginate; a mass ratio of the graphite to the surfactant is preferably 10:(0-2), more preferably 10:(1.0-1.6), and an amount of the cetyltrimethylammonium bromide is not 0.

In the present invention, the alkali liquor is preferably ammonia solution, and the pH value of the alkali liquor is preferably 12; a solid-liquid ratio of the alkali liquor to the graphite is preferably (10-15) mL:1 g, and more preferably (10-12) mL:1 g.

In the present invention, the graphite and a surfactant are preferably mixed and then added into an ammonia solution, and the mixture is dispersed under an ultrasonic condition; the ultrasonic conditions are not particularly limited in the present invention, and the ultrasonic dispersion can be uniformly performed according to a process well known in the art.

In the present invention, after the dispersion is obtained, the dispersion, the water-soluble mesophase pitch and the alcohol solvent are mixed for precipitation reaction, and then aging is performed, so as to obtain a precursor.

In the present invention, a mass ratio of the graphite to the water-soluble mesophase pitch is preferably 10:(0.5-2), more preferably 10:(0.8-1.5), and further preferably 10:1.

In the present invention, the alcohol solvent preferably comprises ethanol; the alcohol solvent plays a role in dispersion; an amount ratio of the alcohol solvent to the graphite is preferably (1-3) mL:1 g, more preferably (1-2) mL:1 g.

In the present invention, a preparation method for the water-soluble mesophase pitch comprises the following steps:
mixing concentrated sulfuric acid, concentrated nitric acid and high-temperature coal tar pitch for a first reaction to obtain a first product;
standing the first product in water, washing until the pH value is 2, mixing an obtained solid product with an alkali solution for a second reaction to obtain a second product; and
mixing a second product with an acid solution for a third reaction to obtain the water-soluble mesophase pitch.

In the present invention, a volume ratio of the concentrated sulfuric acid to the concentrated nitric acid is preferably 3:(0-7), an amount of the concentrated nitric acid is not 0, and a volume ratio of the concentrated sulfuric acid to the concentrated nitric acid is more preferably 3:7; a mass fraction of H₂SO₄ in the concentrated sulfuric acid is preferably 98.3%, and a mass fraction of HNO₃ in the concentrated nitric acid is preferably 65%.

In the present invention, a solid-to-liquid ratio of the high-temperature coal tar pitch to the concentrated sulfuric acid is preferably 1 g:(15-20) mL.

According to the present invention, the concentrated sulfuric acid and the concentrated nitric acid are preferably mixed and stirred for 0.5 h, high-temperature coal tar pitch is added for first reaction to obtain a brown solution (namely a first product); the first product is poured into water for standing for 12 h, the solution is filtered, a filter cake is washed with water until the pH value is 2, the obtained filter cake is put into an alkali solution for second reaction under the stirring condition, the solution is filtered, and a filtrate (namely a second product) is collected; and an acid solution is added into the filtrate for third reaction until the pH value is less than 2.0, the obtained precipitate is allowed to stand for 12 h and filtered, and the obtained filter cake is dried at 100°° C. to obtain the water-soluble mesophase pitch.

The water-soluble mesophase pitch prepared by the present invention can be dissolved in an acid/alkali environment required by coating, is easier to crosslink, and is easier to coat graphite than solid pitch.

In the present invention, the first reaction is performed at a temperature of preferably 30° C. for preferably 30 min.

In the present invention, the alkali solution is preferably 1 mol/L NaOH solution, and the second reaction is performed at a temperature of preferably 80° C. for preferably 5 h.

In the present invention, the acid solution is preferably 1 mol/L hydrochloric acid; and the third reaction is performed at a temperature of preferably 25° C.

The present invention has no particular limitation on the amount of the water, the acid solution and the alkali solution, and can ensure enough amount.

In the present invention, the water-soluble mesophase pitch is preferably added into the dispersion, and the alcohol solvent is added after the uniform stirring at a stirring speed of 220-300 r/min for precipitation reaction.

In the present invention, the temperature of the precipitation reaction is preferably 30-80° C., more preferably 50-60° C.; the time is preferably 0.5-3 h, more preferably 1-2 h; the temperature of the aging is preferably 85-90° C., the time is preferably 10-24 h, more preferably 12-20 h. In the process of the precipitation reaction, positively charged groups of the surfactant are combined with carboxyl/graphite surface hydroxyl groups in the aqueous mesophase pitch, and the negatively charged groups can be combined with positively charged nitro groups in the aqueous mesophase pitch, so that a cross-linked structure is formed. The present invention achieves the process of the material from liquid phase to solid phase through aging, and the aging is performed at higher temperature, which is beneficial to improving the combination rate.

After the aging is completed, the present invention preferably dries the obtained product at 100° C. for 2 h to obtain a precursor.

After the precursor is obtained, the present invention performs first pyrolysis and second pyrolysis on the precursor in the protective gas in sequence to obtain the pitch-based graphite composite material.

In the present invention, the protective gas comprises nitrogen, argon or helium.

In the present invention, the temperature of the first pyrolysis is preferably 300-450° C., more preferably 350-400° C., and the heat preservation time is preferably 5-30 min, more preferably 25 min; the heating rate of heating to the temperature of the first pyrolysis is preferably 3-10° C./min, and more preferably 5-8° C./min; the temperature of the second pyrolysis is preferably 700-800° C., more preferably 750° C., and the heat preservation time is preferably 2-5 h, more preferably 3-4 h; and the heating rate of heating to the second pyrolysis temperature is preferably 3-5° C./min. According to the two pyrolysis processes of the present invention, the first pyrolysis makes the pitch flow uniformly on the surface of the graphite, so that a better coating effect is achieved, and the stripping of a graphite sheet layer is limited; the second pyrolysis increases the degree of graphitization of pitch and improves the conductivity of pitch, and more defects are produced on the surface of pitch-based materials, which is more conducive to the storage of lithium ions.

After the second pyrolysis is completed, the temperature is naturally reduced to room temperature in the protective gas in the present invention, so that the pitch-based graphite composite material is obtained.

The present invention provides a pitch-based graphite composite material prepared by the preparation method according to the above technical solution, which comprises: graphite and pitch carbon microspheres coated on a surface of the graphite, wherein the pitch carbon microspheres are connected to the graphite through a surfactant.

In the present invention, the surfactant is connected to the hydrophilic end of the aqueous mesophase pitch and the carbon layer on the graphite surface, thereby completing the coating.

The present invention provides an application of the pitch-based graphite composite material according to the above technical solution in a negative electrode material for a lithium-ion battery. The present invention has no particular limitation on the application method. The application can be performed based on a method well known in the art.

The technical solutions provided by the present invention will be described in detail below with reference to examples, which, however, should not be construed as limiting the scope of the present invention.

In the following examples, a mass fraction of H₂SO₄ in the concentrated sulfuric acid is 98.3%, and a mass fraction of HNO₃ in the concentrated nitric acid is 65%.

### Example 1

Mixing 30 mL of concentrated H₂SO₄ with 70 mL of concentrated HNO₃, putting the mixture into a stirrer for stirring for 0.5 h, then adding 2 g of high-temperature coal tar pitch, and reacting the mixture for 30 min after the temperature reaches the set temperature of 30° C.; after the reaction is completed, pouring reactants into 500 mL of distilled water, standing for 12 h, then pouring the reactants into a funnel for filtration, washing a filter cake until the pH value is 2, pouring the filter cake into 1000 mL of NaOH solution with a concentration of 1 mol/L after filtration, stirring and reacting for 5 h at 80° C., and filtering and collecting filtrate; adding 1 mol/L hydrochloric acid into the filtrate until the solution is precipitated (pH is less than 2.0), standing for 12 h, filtering, and drying the filter cake at 100° C. to obtain water-soluble mesophase pitch;
mixing 10 g of spherical graphite (with a purity of 99.9%) and cetyltrimethylammonium bromide (CTAB) based on a mass ratio of 10:1.6, putting the mixture into a beaker, adding the mixture into 100 mL of ammonia solution with the pH value of 12, and dispersing the mixture in ultrasound to obtain a dispersion;
adding 1 g of the prepared water-soluble mesophase pitch into the dispersion, uniformly stirring at the temperature of 30° C. at the stirring speed of 220 r/min, adding 10 mL of ethanol, continuously stirring for precipitation reaction for 3 h, performing aging in a water bath at the temperature of 85° C. for 24 h, and drying the obtained precipitate at the temperature of 100° C. for 2 h to obtain a precursor; and
transferring the precursor into a tubular furnace, introducing high-purity nitrogen (with a purity of 99.9%), heating to 450° C. at a heating rate of 3° C./min, keeping the temperature for 25 min, continuing heating to 800° C. at a heating rate of 5° C./min, keeping the temperature for 2 h, and then cooling to room temperature under the nitrogen atmosphere to obtain the pitch-based graphite composite material.

### Example 2

Mixing 70 mL of concentrated H₂SO₄ with 30 mL of concentrated HNO₃, putting the mixture into a stirrer for stirring for 0.5 h, then adding 3.5 g of high-temperature coal tar pitch, and reacting the mixture for 30 min after the temperature reaches the set temperature of 30° C.; after the reaction is completed, pouring reactants into 500 mL of distilled water, standing for 12 h, then pouring the reactants into a funnel for filtration, washing a filter cake until the pH value is 2, pouring the filter cake into 1000 mL of NaOH solution with a concentration of 1 mol/L after filtration, stirring and reacting for 5 h at 80° C., and filtering and collecting filtrate; adding 1 mol/L hydrochloric acid into the filtrate until the solution is precipitated (pH is less than 2.0), standing for 12 h, filtering, and drying the filter cake at 100° C. to obtain water-soluble mesophase pitch;
mixing 10 g of spherical graphite (with a purity of 99.9%) and cetyltrimethylammonium bromide (CTAB) based on a mass ratio of 10:1.6, putting the mixture into a beaker, adding the mixture into 100 mL of ammonia solution with the pH value of 12, and dispersing the mixture in ultrasound to obtain a dispersion;
adding 1 g of the prepared water-soluble mesophase pitch into the dispersion, uniformly stirring at the temperature of 30° C. at the stirring speed of 220 r/min, adding 10 mL of ethanol, continuously stirring for precipitation reaction for 3 h, performing aging in a water bath at the temperature of 85° C. for 24 h, and drying the obtained precipitate at the temperature of 100° C. for 2 h to obtain a precursor; and
transferring the precursor into a tubular furnace, introducing high-purity nitrogen (with a purity of 99.9%), heating to 450° C. at a heating rate of 3° C./min, keeping the temperature for 25 min, continuing heating to 800° C. at a heating rate of 5° C./min, keeping the temperature for 2 h, and then cooling to room temperature under the nitrogen atmosphere to obtain the pitch-based graphite composite material.

### Example 3

Mixing 30 mL of concentrated H₂SO₄ with 70 mL of concentrated HNO₃, putting the mixture into a stirrer for stirring for 0.5 h, then adding 2 g of high-temperature coal tar pitch, and reacting the mixture for 30 min after the temperature reaches the set temperature of 30° C.; after the reaction is completed, pouring reactants into 500 mL of distilled water, standing for 12 h, then pouring the reactants into a funnel for filtration, washing a filter cake until the pH value is 2, pouring the filter cake into 1000 mL of NaOH solution with a concentration of 1 mol/L after filtration, stirring and reacting for 5 h at 80°° C., and filtering and collecting filtrate; adding 1 mol/L hydrochloric acid into the filtrate until the solution is precipitated (pH is less than 2.0), standing for 12 h, filtering, and drying the filter cake at 100° C. to obtain water-soluble mesophase pitch;
mixing 10 g of spherical graphite (with a purity of 99.9%) and cetyltrimethylammonium bromide (CTAB) based on a mass ratio of 10:2, putting the mixture into a beaker, adding the mixture into 100 mL of ammonia solution with the pH value of 12, and dispersing the mixture in ultrasound to obtain a dispersion;
adding 1 g of the prepared water-soluble mesophase pitch into the dispersion, uniformly stirring at the temperature of 30° C. at the stirring speed of 220 r/min, adding 10 mL of ethanol, continuously stirring for precipitation reaction for 3 h, performing aging in a water bath at the temperature of 85° C. for 24 h, and drying the obtained precipitate at the temperature of 100° C. for 2 h to obtain a precursor; and
transferring the precursor into a tubular furnace, introducing high-purity nitrogen (with a purity of 99.9%), heating to 450° C. at a heating rate of 3° C./min, keeping the temperature for 25 min, continuing heating to 800° C. at a heating rate of 5° C./min, keeping the temperature for 2 h, and then cooling to room temperature under the nitrogen atmosphere to obtain the pitch-based graphite composite material.

### Comparative Example 1

Mixing 30 mL of concentrated H₂SO₄ with 70 mL of concentrated HNO₃, putting the mixture into a stirrer for stirring for 0.5 h, then adding 2 g of high-temperature coal tar pitch, and reacting the mixture for 30 min after the temperature reaches the set temperature of 30° C.; after the reaction is completed, pouring reactants into 500 mL of distilled water, standing for 12 h, then pouring the reactants into a funnel for filtration, washing a filter cake until the pH value is 2, pouring the filter cake into 1000 mL of NaOH solution with a concentration of 1 mol/L after filtration, stirring and reacting for 5 h at 80° C., and filtering and collecting filtrate; adding 1 mol/L hydrochloric acid into the filtrate until the solution is precipitated (pH is less than 2.0), standing for 12 h, filtering, and drying the filter cake at 100°° C. to obtain water-soluble mesophase pitch;
adding 10 g of spherical graphite (with a purity of 99.9%) into 100 mL of ammonia solution with the pH value of 12, and dispersing the mixture in ultrasound to obtain a dispersion;
adding 1 g of the prepared water-soluble mesophase pitch into the dispersion, uniformly stirring at the temperature of 30° C. at the stirring speed of 220 r/min, adding 10 mL of ethanol, continuously stirring for precipitation reaction for 3 h, performing aging in a water bath at the temperature of 85° C. for 24 h, and drying the obtained precipitate at the temperature of 100° C. for 2 h to obtain a precursor; and
transferring the precursor into a tubular furnace, introducing high-purity nitrogen (with a purity of 99.9%), heating to 450° C. at a heating rate of 3° C./min, keeping the temperature for 25 min, continuing heating to 800° C. at a heating rate of 5° C./min, keeping the temperature for 2 h, and then cooling to room temperature under the nitrogen atmosphere to obtain the pitch-based graphite composite material.

### Comparative Example 2

mixing 10 g of spherical graphite (with a purity of 99.9%) and cetyltrimethylammonium bromide (CTAB) based on a mass ratio of 10:1.6, putting the mixture into a beaker, adding the mixture into 100 mL of ammonia solution with the pH value of 12, and dispersing the mixture in ultrasound to obtain a dispersion;
adding 1 g of the prepared high-temperature coal tar pitch into the dispersion, uniformly stirring at the temperature of 30°° C. at the stirring speed of 220 r/min, adding 10 mL of ethanol, continuously stirring for precipitation reaction for 3 h, performing aging in a water bath at the temperature of 85° C. for 24 h, and drying the obtained precipitate at the temperature of 100° C. for 2 h to obtain a precursor; and
transferring the precursor into a tubular furnace, introducing high-purity nitrogen (with a purity of 99.9%), heating to 450° C. at a heating rate of 3° C./min, keeping the temperature for 25 min, continuing heating to 800° C. at a heating rate of 5° C./min, keeping the temperature for 2 h, and then cooling to room temperature under the nitrogen atmosphere to obtain the pitch-based graphite composite material.

### Comparative Example 3

Untreated spheroidal graphite (with a purity of 99.9%) was used as Comparative Example 3.

### Characterization

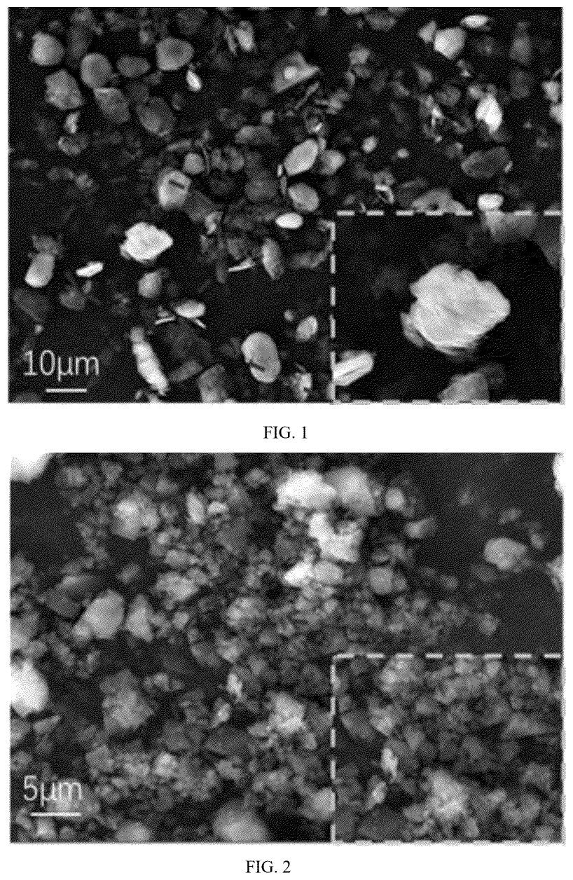

FIG. 1 is an SEM image of high-temperature coal tar pitch used in Example 1. It can be seen from FIG. 1 that the high-temperature coal tar pitch has a large block structure.

FIG. 2 is an SEM image of water-soluble mesophase pitch prepared in Example 1. It can be seen from FIG. 2 that the particle size becomes smaller and more dispersed after the acid washing treatment.

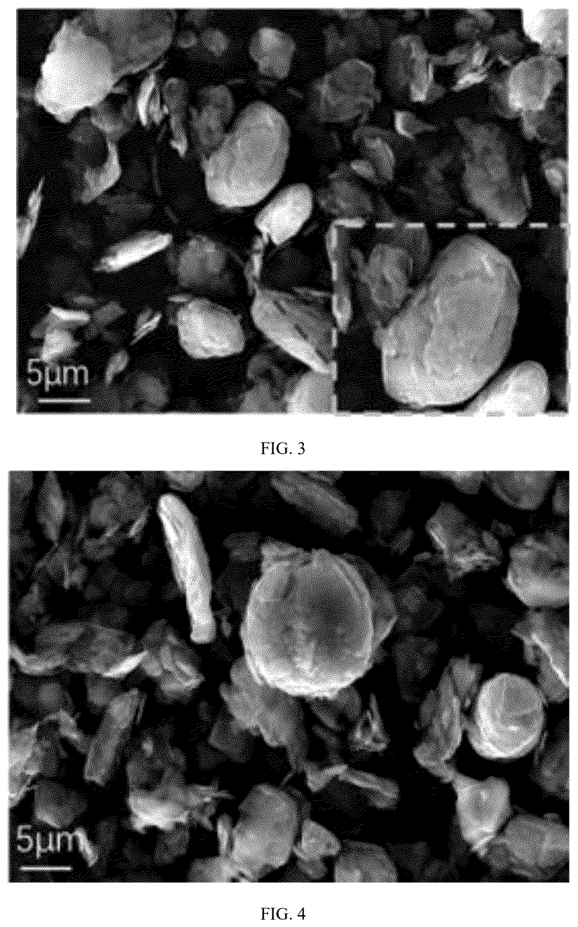

FIG. 3 is an SEM image of a raw material spherical graphite according to Example 1. It can be seen from FIG. 3 that the graphite has a spherical structure.

FIG. 4 is an SEM image of a pitch-based graphite composite material according to Example 1. It can be seen from FIG. 4 that the original morphology of the spherical graphite is not changed by the coating.

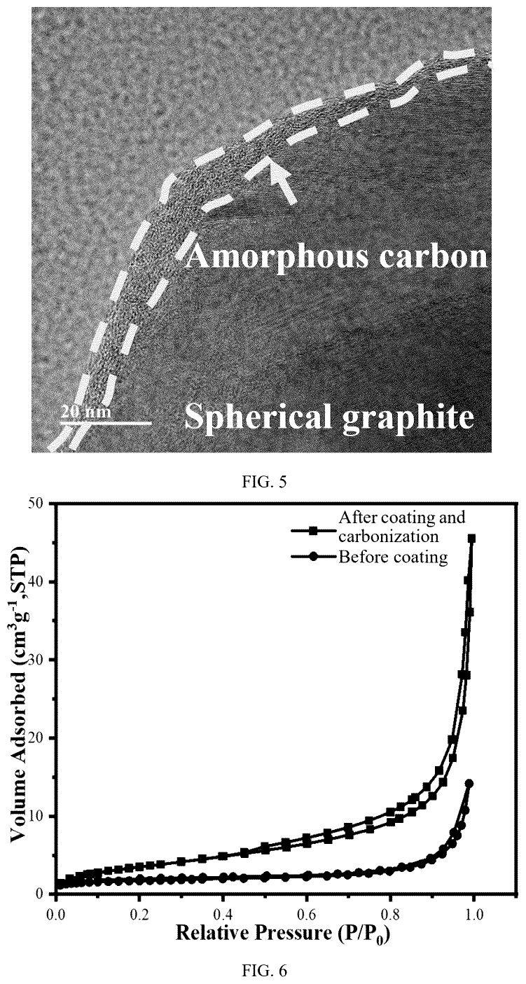

FIG. 5 is a TEM image of a pitch-based graphite composite material according to Example 1. It can be seen from FIG. 5 that the material is uniformly coated on the surface of spherical graphite, with the outer layer being an amorphous carbon layer and the inner layer being layered graphite.

FIG. 6 is a curve showing the pore size distribution of a raw material graphite (before coating) and a pitch-based graphite composite material (after coating and carbonization) according to Example 1. It can be seen from FIG. 6 that the prepared pitch-based graphite composite material has a porous structure, and after coating, the specific surface area of the material is increased, which is beneficial to desolvation reaction in the charging and discharging processes of a lithium-ion battery, thereby improving the electrochemical performance.

### Application Test Example

0.1 g of the pitch-based graphite composite materials prepared in Examples 1 to 3 and Comparative Examples 1 to 3 were mixed with 0.0125 g of acetylene black and 0.0125 g of PVDF (polyvinylidene fluoride) binder in N-methyl-2-pyrrolidone (NMP) for 4 h until a uniform flowable slurry was generated, the slurry was coated on a copper foil and dried at 80° C. for 12 h, the resulting material was loaded in a CR2032 button cell, which was placed in a blue cell test system, and charge and discharge were conducted under a current of 1A g⁻¹. The results are found in Table 1.

TABLE 1
Raw material amounts and prepared material properties
of Examples 1 to 3 and Comparative Examples 1 to 3

| | Amount of | Amount of | | First-cycle | 1000-cycle |
|---|---|---|---|---|---|
| | concentrated | concentrated | | discharging | discharging |
| | sulfuric | nitric | | specific | specific |
| Case | acid/mL | acid/mL | CTAB/g | capacity/mAh g⁻¹ | capacity/mAh g⁻¹ |
| Example 1 | 30 | 70 | 1.6 | 557.6 | 225.1 |
| Example 2 | 70 | 30 | 1.6 | 461.8 | 152.5 |
| Example 3 | 30 | 70 | 2 | 476.3 | 184.7 |
| Comparative | 30 | 70 | 0 | 406.2 | 104.3 |
| Example 1 | | | | | |
| Comparative | — | — | 1.6 | 400.1 | 145.1 |
| Example 2 | | | | | |
| Comparative | — | — | — | 350.1 | 93.3 |
| Example 3 | | | | | |

It can be seen from Table 1 that the pitch-based graphite composite material prepared by the present invention has good cycle performance. It can be found from Examples 1 and 2 that increase in the proportion of nitric acid is more favorable for improving the cycle performance of the material, and the introduction of more nitro groups into the surface of the aqueous mesophase pitch is more favorable for the combination of the material. Comparative Example 2 uses high-temperature coal tar pitch, but does not use the water-soluble mesophase pitch used in the present invention, which reduces the electrical properties of the material. By comparing Examples 1 to 3 with Comparative Example 1, it can be found that the material with the addition of CTAB has better cycle performance and can effectively improve the high-rate charging performance of the material; however, it is not advisable to add too much CTAB. The lithium storage performance and the capacity retention rate of the coated pitch-based graphite composite material are superior to those of uncoated spherical graphite, and the coating means can effectively improve the electrochemical performance of the material.

The above descriptions are only preferred embodiments of the present invention. It should be noted that those of ordinary skill in the art can also make several improvements and modifications without departing from the principle of the present invention, and such improvements and modifications shall fall within the protection scope of the present invention.

What is claimed is:

1. A preparation method for a pitch-based graphite composite material, comprising the following steps:
mixing graphite, a surfactant, and an alkali liquor to obtain a dispersion;
mixing the dispersion, a water-soluble mesophase pitch, and an alcohol solvent, performing a precipitation reaction, and then aging to obtain a precursor; and
sequentially performing a first pyrolysis and a second pyrolysis on the precursor in a protective gas to obtain the pitch-based graphite composite material.

2. The preparation method according to claim 1, wherein the surfactant comprises cetyltrimethylammonium bromide, polyvinylpyrrolidone, carboxymethyl cellulose, or sodium alginate; a mass ratio of the graphite to the surfactant is 10:(0-2), and an amount of the cetyltrimethylammonium bromide is not 0.

3. The preparation method according to claim 1, wherein a preparation method for the water-soluble mesophase pitch comprises the following steps:
mixing a concentrated sulfuric acid, a concentrated nitric acid, and a high-temperature coal tar pitch for a first reaction to obtain a first product, wherein the high-temperature coal tar pitch is a coal tar pitch with a softening point greater than 95° C.;
standing the first product in water, washing until a pH value is 2, mixing an obtained solid product with an alkali solution for a second reaction to obtain a second product; and
mixing the second product with an acid solution for a third reaction to obtain the water-soluble mesophase pitch.

4. The preparation method according to claim 3, wherein a volume ratio of the concentrated sulfuric acid to the concentrated nitric acid is 3:(0-7), an amount of the concentrated nitric acid is not 0, a mass fraction of H₂SO₄ in the concentrated sulfuric acid is 98.3%, and a mass fraction of HNO₃ in the concentrated nitric acid is 65%.

5. The preparation method according to claim 1, wherein a mass ratio of the graphite to the water-soluble mesophase pitch is 10:(0.5-2), and the alcohol solvent comprises ethanol.

6. The preparation method according to claim 1, wherein the precipitation reaction is performed at a temperature of 30-80° C. for 0.5-3 h, and the aging is performed at a temperature of 85-90° C. for 10-24 h.

7. The preparation method according to claim 1, wherein the protective gas comprises nitrogen, argon, or helium.

8. The preparation method according to claim 1, wherein the first pyrolysis is performed at a temperature of 300-450° C., and a heat preservation time of the first pyrolysis is 5-30 min; a heating rate of heating to the temperature of 300-450° C. for the first pyrolysis is 3-10° C./min; the second pyrolysis is performed at a temperature of 700-800° C., and a heat preservation time of the second pyrolysis is 2-5 h; and a heating rate of heating to the temperature of 700-800° C. for the second pyrolysis is 3-5° C./min.

9. A pitch-based graphite composite material prepared by the preparation method according to claim 1, comprising: the graphite and pitch carbon microspheres coated on a surface of the graphite, wherein the pitch carbon microspheres are connected to the graphite through the surfactant.

10. The pitch-based graphite composite material according to claim 9, wherein the pitch-based graphite composite material is used in a negative electrode material for a lithium-ion battery.

11. The preparation method according to claim 3, wherein a mass ratio of the graphite to the water-soluble mesophase pitch is 10:(0.5-2), and the alcohol solvent comprises ethanol.

12. The preparation method according to claim 4, wherein a mass ratio of the graphite to the water-soluble mesophase pitch is 10:(0.5-2), and the alcohol solvent comprises ethanol.

13. The preparation method according to claim 7, wherein the first pyrolysis is performed at a temperature of 300-450° C., and a heat preservation time of the first pyrolysis is 5-30 min; a heating rate of heating to the temperature of 300-450° C. for the first pyrolysis is 3-10° C./min; the second pyrolysis is performed at a temperature of 700-800° C., and a heat preservation time of the second pyrolysis is 2-5 h; and a heating rate of heating to the temperature of 700-800° C. for the second pyrolysis is 3-5° C./min.

14. The pitch-based graphite composite material according to claim 9, wherein in the preparation method, the surfactant comprises cetyltrimethylammonium bromide, polyvinylpyrrolidone, carboxymethyl cellulose, or sodium alginate; a mass ratio of the graphite to the surfactant is 10:(0-2), and an amount of the cetyltrimethylammonium bromide is not 0.

15. The pitch-based graphite composite material according to claim 9, wherein in the preparation method, a preparation method for the water-soluble mesophase pitch comprises the following steps:
mixing a concentrated sulfuric acid, a concentrated nitric acid, and a high-temperature coal tar pitch for a first reaction to obtain a first product, wherein the high-temperature coal tar pitch is a coal tar pitch with a softening point greater than 95° C.;
standing the first product in water, washing until a pH value is 2, mixing an obtained solid product with an alkali solution for a second reaction to obtain a second product; and
mixing the second product with an acid solution for a third reaction to obtain the water-soluble mesophase pitch.

16. The pitch-based graphite composite material according to claim 15, wherein in the preparation method, a volume ratio of the concentrated sulfuric acid to the concentrated nitric acid is 3:(0-7), an amount of the concentrated nitric acid is not 0, a mass fraction of H₂SO₄ in the concentrated sulfuric acid is 98.3%, and a mass fraction of HNO₃ in the concentrated nitric acid is 65%.

17. The pitch-based graphite composite material according to claim 9, wherein in the preparation method, a mass ratio of the graphite to the water-soluble mesophase pitch is 10:(0.5-2), and the alcohol solvent comprises ethanol.

18. The pitch-based graphite composite material according to claim 9, wherein in the preparation method, the precipitation reaction is performed at a temperature of 30-80° C. for 0.5-3 h, and the aging is performed at a temperature of 85-90° C. for 10-24 h.

19. The pitch-based graphite composite material according to claim 9, wherein in the preparation method, the protective gas comprises nitrogen, argon, or helium.

20. The pitch-based graphite composite material according to claim 9, wherein in the preparation method, the first pyrolysis is performed at a temperature of 300-450° C., and a heat preservation time of the first pyrolysis is 5-30 min; a heating rate of heating to the temperature of 300-450° C. for the first pyrolysis is 3-10° C./min; the second pyrolysis is performed at a temperature of 700-800° C., and a heat preservation time of the second pyrolysis is 2-5 h; and a heating rate of heating to the temperature of 700-800° C. for the second pyrolysis is 3-5° C./min.
